(19) United States
(12) Patent Application Publication
(10) Pub. No.: US 2013/0204635 A1
(43) Pub. Date: Aug. 8, 2013

(54) SCHEDULE PRESENTATION DEVICE

(71) Applicant: OLYMPUS MEDICAL SYSTEMS CORP., Tokyo (JP)

(72) Inventors: Keiji OKUMURA, Tokyo (JP); Yusuke KATO, Tokyo (JP); Takashi HOSAKA, Tokyo (JP); Koji SUZUKI, Tokyo (JP)

(73) Assignee: OLYMPUS MEDICAL SYSTEMS CORP., Tokyo (JP)

(21) Appl. No.: 13/753,787

(22) Filed: Jan. 30, 2013

Related U.S. Application Data
(63) Continuation of application No. PCT/JP2012/001330, filed on Feb. 27, 2012.

(30) Foreign Application Priority Data
Mar. 14, 2011 (JP) 2011-055443

(51) Int. Cl. G06Q 10/10; G06Q 50/22

(52) U.S. Cl. CPC G06Q 10/1095; G06Q 50/22
USPC 705/2

(57) ABSTRACT

In a schedule presentation device that presents to a user examination schedule information including an execution time of an examination and an examination room to perform the examination, an examination information processing unit processes examination information. An examination information storage stores the examination information. A screen image generating unit generates an examination schedule screen image including an unallocated examination display region and a schedule display region. An examination information processing unit extracts: unallocated examination information on examinations to which an execution time or an examination room is not allocated; and allocated examination information on examinations to which an execution time and an examination room are allocated, from the examination information. The screen image generating unit generates data for displaying the unallocated examination information in the unallocated examination display region, and data for displaying the allocated examination information in the examination schedule screen image.

### CROSS-REFERENCE TO RELATED APPLICATIONS

This application is a continuation of and claims priority to PCT/JP2012/001330 filed Feb. 27, 2012, which claims the benefit of and priority from Japanese Patent Application No. 2011-55443 filed Mar. 14, 2011, the entire contents of these applications are incorporated herein by reference.

### BACKGROUND OF THE INVENTION

1. Field of the Invention

The present invention generally relates to schedule presentation devices, and more particularly, to a device for managing schedules in a facility where a medical practice (e.g., an examination or the like) is performed.

2. Description of the Related Art

In a medical facility, such as a hospital or the like, effective scheduling management is required in order to utilize medical equipment, medical facilities, and human resources efficiently, and in order to cut down waiting time for examinees. According to prior arts, technologies have been proposed for determining allocation of facilities (e.g., devices, rooms or the like), medical staffs (e.g., medical technologists or the like), examinees, or the like to each medical practice so as to support scheduling management.

In the patent document No. 1, an examination management system is presented. The system receives input for canceling an examination, determines whether or not a walk-in examination for which a request is received can be performed at a time window for the canceled examination, determines the order of examinations, and notifies a person who submitted the request or a client in an examination room of information on the walk-in examination.

In the patent document No. 2, a scheduling management system is presented. The system can display schedule information that associates a radiological technologist who performs an examination, a radiography room or modality, and a date with one other. In this management system, the job title, expertness, level of proficiency, or the like of technologists are referred to and a technologist is allocated in accordance with a modality in a radiography room, the number of examinees for each radiography room, or the like.

In the patent document No. 3, a determination device for determining a technologist in charge is presented. The determination device determines a medical technologist who is estimated to have the highest processing capabilities for each examination room and presents the medical technologist determined for each room through a display device to a person who controls the determination device. This determination device determines, for all examination rooms that have reserved for a biopsy, a medical technologist on the basis of the anticipated number of biopsies for each type of biopsy that is scheduled to be performed in each examination room, and on the basis of the skill level of each medical technologist for each kind of biopsy.

In the patent document No. 4, an operation schedule display system is presented. The system acquires operation order information or the like and displays scheduled operation time and actual operation execution time by using graphic symbols.

In the patent document No. 5, an ME device management system is presented. The system generates and manages charts for each ME device, the charts including information on a control department, an installation location, or the like, in order to manage the installation location of medical devices. This system comprises a function for displaying a ME device installed for each patients room.

In the patent document No. 6, an input guide method and device is presented. The method and device display a specified bed layout plan on an inpatient reception terminal device when allocating a bed for an inpatient.

In the patent document No. 7, a system for generating an approved care insurance schedule is presented. In the system, a time schedule table of a review board meeting is referred to, and a board meeting is allocated in accordance with a notification date of approval of an applicant.

### RELATED ART LIST

### Patent Document

[Patent Document 1] Japanese Patent Application Publication No. 2006-338567.
[Patent Document 2] Japanese Patent Application Publication No. 2004-157877.
[Patent Document 3] Japanese Patent Application Publication No. 2008-250502.
[Patent Document 4] Japanese Patent Application Publication No. 2007-122174.
[Patent Document 5] Japanese Patent Application Publication No. H11-154195.
[Patent Document 6] Japanese Patent Application Publication No. H9-153097.
[Patent Document 7] Japanese Patent Application Publication No. H11-282922.

When making a reservation for an examination in a medical institution such as a hospital or the like, a medical staff (e.g., a doctor or the like) issues an examination order in which sometimes only a date for the examination is specified, and sometimes a time and date for the examination is specified. In practice, in many institutions, even in case that a time for an examination is also specified, a precise time and sequence of examinations are not specified at the time of reservation, and instead thereof, for example, a day is divided into a plurality of time frames and examinations are allocated to each time frame up to the number of examinations that can be carried out. Further, in case that there are a plurality of examination devices of similar type and/or a plurality of examination rooms, equipment to be used and/or an examination room to be used are often not specified at the time of reservation.

Therefore, it is required to further schedule an examination room to be used and/or an actual examination time. In most cases, an examination room and an examination time are allocated to each examination in the night right before the examination or in the morning of the examination after all examination reservations for the day are made. Wide range of issues should be considered when making an examination schedule. Thus making a schedule while grasping a variety of conditions simultaneously is not easy even for a skilled person in charge.

In addition, a change or an adjustment of a schedule is often required after the schedule has been once made. One of the reasons thereof is that, when an examination schedule is drawn up in advance, a standard examination time period (herein after also referred to as a “standard required examination time”) and a standard time interval between examinations are assumed to be certain values in order to schedule examinations. However, the standard required examination time and the standard time interval are merely an averaged value, and in practice sometimes vary according to individual symptoms and/or circumstances. For example, sometimes an examination is performed for a time period that is longer than a scheduled time period because a suspiciously-diseased part has been found during the examination, and sometimes an examination time period is reduced because a scheduled treatment has been determined to be unnecessary and has been canceled as a result of a diagnosis.

Sometimes a walk-in examination for an emergency case is required or an examination is suddenly canceled due to a change of examinee's condition. Sometimes the number of available examination rooms may change due to a trouble of medical equipment or of an examination room. In order to deal with such circumstances, it is required to detect the necessity to change an examination schedule as early as possible, and to change the examination schedule at an early stage. Therefore, a scheme is required for presenting at appropriate timing the statuses of respective examinations (e.g., cancellation status of examinations, an urgently occurred examination order, the progression status of examinations, or the like) in addition to an examination schedule to a person who manages the schedule, where the statuses of respective examinations vary momentarily.

### SUMMARY OF THE INVENTION

In this background, a purpose of the present invention is to provide a system that supports effective management of an examination schedule.

In order to address the aforementioned issue, a schedule presentation device that presents examination schedule information, which includes a time to perform an examination and an examination room to perform the examination, to a user is provided according to an aspect of the present invention. The schedule presentation device includes: an examination information processing unit operative to process examination information; an examination information storage operative to store the examination information; and a screen image generating unit operative to generate an examination schedule screen image configured as a 2-dimensional matrix where one axis indicates execution times of examinations and the other axis indicates examination rooms. The examination information processing unit includes: an allocated examination extraction unit operative to extract allocated examination information, which is information on examinations to which an execution time and an examination room are allocated, from the examination information stored in the examination information storage; and an unallocated examination extraction unit operative to extract unallocated examination information, which is information on examinations to which an execution time or an examination room is not allocated, from the examination information stored in the examination information storage. In the examination schedule screen image, the axis of execution time indicates a time-undetermined-examination-displaying field for displaying examination information on an examination for which an examination time is not determined, along with a time of each examination of the examination information, and the axis of examination room indicates an examination-room-undetermined-examination-displaying field for displaying examination information on an examination for which an examination room is not determined, along with an examination room of each examination of the examination information. The screen image generating unit includes: a schedule display generating unit operative to generate data for displaying the allocated examination information extracted by the allocated examination extraction unit at a position specified by the axis of execution time and by the axis of examination room in a schedule display region for displaying the allocated examination information in the examination schedule screen image; and an unallocated display generating unit operative to generate data for displaying the unallocated examination information, extracted by the unallocated examination extraction unit, in an unallocated examination display region including the time-undetermined-examination-displaying field and the examination-room-undetermined-examination-displaying field.

Optional combinations of the aforementioned constituting elements, and implementations of the invention in the form of methods, apparatuses, systems, computer programs, a recording media that store computer programs, and data structures may also be practiced as additional modes of the present invention.

### BRIEF DESCRIPTION OF THE DRAWINGS

FIG. 1 shows a configuration of a medical service support system including a schedule presentation device according to an exemplary embodiment;

FIG. 2 shows an example of an examination information table stored in an examination information storage in the schedule presentation device shown in FIG. 1;

FIG. 3 shows an example of an examination schedule screen image that a screen image generating unit of the schedule presentation device shown in FIG. 1 generates and that is displayed on a display device;

FIG. 4 shows another example of an examination schedule screen image that the screen image generating unit of the schedule presentation device shown in FIG. 1 generates and that is displayed on a display device;

FIG. 5 shows a state where a user drags downwards the lower side of a graphic symbol that indicates an examination and that is displayed in a schedule display region on the examination schedule screen image shown in FIG. 4;

FIG. 6 shows a configuration of an examination information processing unit in the schedule presentation device shown in FIG. 1;

FIG. 7 shows a configuration of a screen image generating unit in the schedule presentation device shown in FIG. 1;

FIG. 8 shows an example of an examination schedule screen image that the screen image generating unit of the schedule presentation device shown in FIG. 1 generates and that is displayed on a display device, in case that an examination to which a time is not assigned is not included in examination information;

FIG. 9 shows an example of a hint display that is displayed when a user specifies one of the examinations in the examination schedule screen image shown in FIG. 3;

FIG. 10 shows an example of an examination frame graphic symbol that is displayed when a user indicates one of the unallocated examinations in the examination schedule screen image shown in FIG. 4;

FIG. 11 shows a screen image for allowing a user to input a specification condition that specifies to which unallocated examination an examination room and/or an examination time is to be assigned when an automatic allocation process is performed; and

FIG. 12 shows a flowchart indicating a procedure where a user allocates one of unallocated examinations to an available examination room and to an available time window by using the schedule presentation device shown in FIG. 1.

### DETAILED DESCRIPTION OF THE INVENTION

The invention will now be described by reference to the preferred embodiments. This does not intend to limit the scope of the present invention, but to exemplify the invention.

First, a brief overview will be given on an exemplary embodiment. A schedule presentation device according to the exemplary embodiment displays an examination schedule on a screen in a manner where the examination schedule can be grasped intuitively, and presents the schedule to a user such as a person in charge of managing examinations. The examination schedule determines, for each examination, a time to perform the examination and an examination room to be used for the examination. In this document, an “examination execution time” refers to: a) a time point to start an examination; b) a time point to start an examination and a time period required for the examination; or c) a time point to start an examination and a time point to end the examination. The schedule presentation device according to the exemplary embodiment further allows an examination schedule screen image to reflect a cancellation of an examination of which the notice is received on the day of the examination, the progression status of an examination, the arrival status of an examinee, or the like on an as needed basis. The schedule presentation device also displays an unallocated examination to which an examination room and/or a time is not assigned (e.g., an examination order issued urgently) in the same screen image.

A user (e.g., a person in charge of scheduling examinations) checks an examination schedule screen image, which is displayed by the schedule presentation device, and changes the schedule by taking the latest status into account whenever necessary, for example, the user assigns an unallocated examination to an available examination room, etc. In this process, the schedule presentation device according to the exemplary embodiment presents information for supporting a user to change the schedule, for example by displaying with an emphasis an available examination room and/or an available time window for an unallocated examination. The device also allows a user to change the schedule with an easy operation.

The schedule presentation device according to the exemplary embodiment can also assign one or more unallocated examinations to an available examination room and to an available time slot automatically in accordance with a condition specified by a user.

By referring to figures, an explanation will be given below on the configuration of a schedule presentation device 100 according to an exemplary embodiment of the present invention.

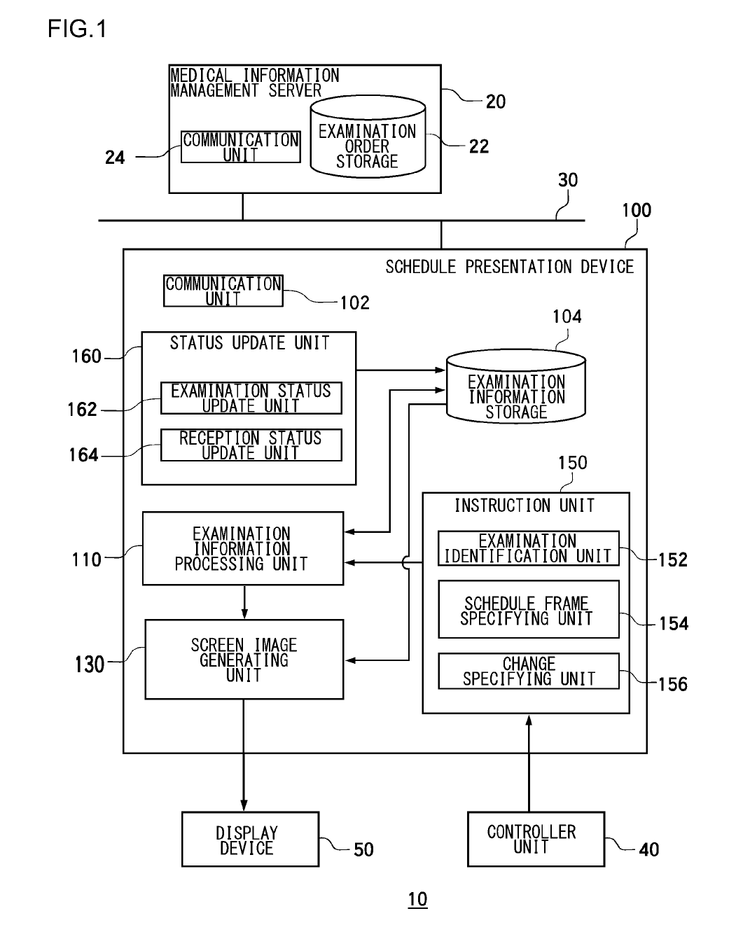

FIG. 1 shows a configuration of a medical service support system 10 including the schedule presentation device 100 according to the exemplary embodiment. The medical service support system 10 is installed in a medical facility, and comprises a medical information management server 20 and the schedule presentation device 100. The medical information management server 20 manages medical information, which relates to a medical practice, such as an examination to be performed for an examinee, or the like. The schedule presentation device 100 presents examination schedule information to a person in charge of scheduling. In this document, “examination schedule information” refers to information that associates each medical practice (e.g., an examination) with a facility to perform the medical practice and/or with a time to perform the medical practice, etc.

The medical information management server 20 and the schedule presentation device 100 are communicably connected via a network 30, such as, an intranet, a local area network (LAN), a wide area network (WAN), a virtual private network (VPN), the Internet, or the like.

The medical information management server 20 compiles order information issued by a system (not shown) of each clinical faculty in a medical facility into a database so as to manage the order information. The order information is issued by a medical staff (e.g., a doctor, a nurse or the like) and specifies medical service. The medical information management server 20 comprises an examination order storage 22 that stores an examination order issued by a doctor, the examination order included in medical information, and a communication unit 24 that sends and receives data to and from another server, a system, a client terminal, or the like via a network.

An examination order stored in the examination order storage 22 includes items such as an examination ID that uniquely identifies each examination, an examination date and time that indicates a date and time when the examination is scheduled to be performed, an examinee ID that uniquely identifies an examinee who is to undergo the examination, an examination type that indicates the type of the examination, an appointed doctor, an examinee type that indicates whether the examinee is an inpatient or an outpatient, infection information in case the examinee is infected, or the like.

The “appointed doctor” included in the examination order items specifies a medical staff (e.g., a doctor or a technician in charge of the examination) who is appointed in case an examinee would like the medical staff to perform the examination, or in case of certain types of examinations, which only one or a limited number of medical staffs can perform. As the examination date and time included in the examination order items, sometimes only a scheduled date for the examination is specified, and sometimes a time for the examination is also specified.

The schedule presentation device 100 is connected to a controller unit 40, and to a display device 50. The controller unit 40 is configured so that a user (e.g., a person in charge of examination schedule management) can input an instruction to the schedule presentation device 100 by manipulation for example through a keyboard, a touch pen, a touch panel, or the like, by voice input via a microphone or the like, or by other input means such as optical means, electromagnetic means, or the like. The display device 50 is configured with a display or the like for presenting examination schedule information created by the schedule presentation device 100 to a user (e.g., a person in charge of examination schedule management, a doctor in charge of an examination, an examinee, or the like).

The controller unit 40 and the display device 50 may be configured as a part of the schedule presentation device 100. The controller unit 40 and the display device 50 may be formed as one piece as a user interface, such as a touch display or the like.

Although one controller unit 40 and one display device 50 are shown in FIG. 1, a plurality of controller units 40 and/or a plurality of display devices 50 may be provided. For example, a controller unit 40 and a display device 50 may be provided in each examination room besides a controller unit 40 and a display device 50 for a person in charge of examination schedule management installed in a nurse station and/or at a reception. This allows a medical technologist, a doctor, or the like to create/change an examination schedule in accordance with his/her own schedule while checking the statuses of examinations of respective examination rooms.

A display device 50 may also be installed in a waiting lounge so that examinees can check an examination schedule by themselves. The display device 50 may be configured as a mobile terminal such as a Personal Digital Assistant (PDA) or the like that is rented when an examinee goes out of an examination department while waiting for an examination. This allows the examinee to check the progression status of examinations, a change of schedule, or the like by himself/herself so that he/she can use time efficiently and the stress that the examinee feels during waiting time is alleviated. Further, a medical staff (e.g., a nurse or the like) can avoid a situation where the staff is busy responding to examinees who inquire about waiting time and the staff cannot afford time for his/her own service in case that there is a delay in the examination schedule.

The schedule presentation device 100 comprises a communication unit 102, an examination information storage 104, an examination information processing unit 110, a screen image generating unit 130, an instruction unit 150, and a status update unit 160. The communication unit 102 sends and receives data to and from the medical information management server 20 or the like. The examination information storage 104 stores examination information. The examination information processing unit 110 processes examination information in order to support planning a schedule of examinations. The screen image generating unit 130 generates an examination schedule screen image for presenting examination information to a user. The instruction unit 150 receives an instruction input through the controller unit 40 by a user and specifies a process to be performed by the examination information processing unit 110. The status update unit 160 acquires the progression status of examinations, information on the arrival of an examinee, or the like and updates the examination information. In this document, the examination information refers to information including: examination order information; status information indicating the actual progression status of examinations, the arrival status of examinees, or the like; and examination schedule information for each examination.

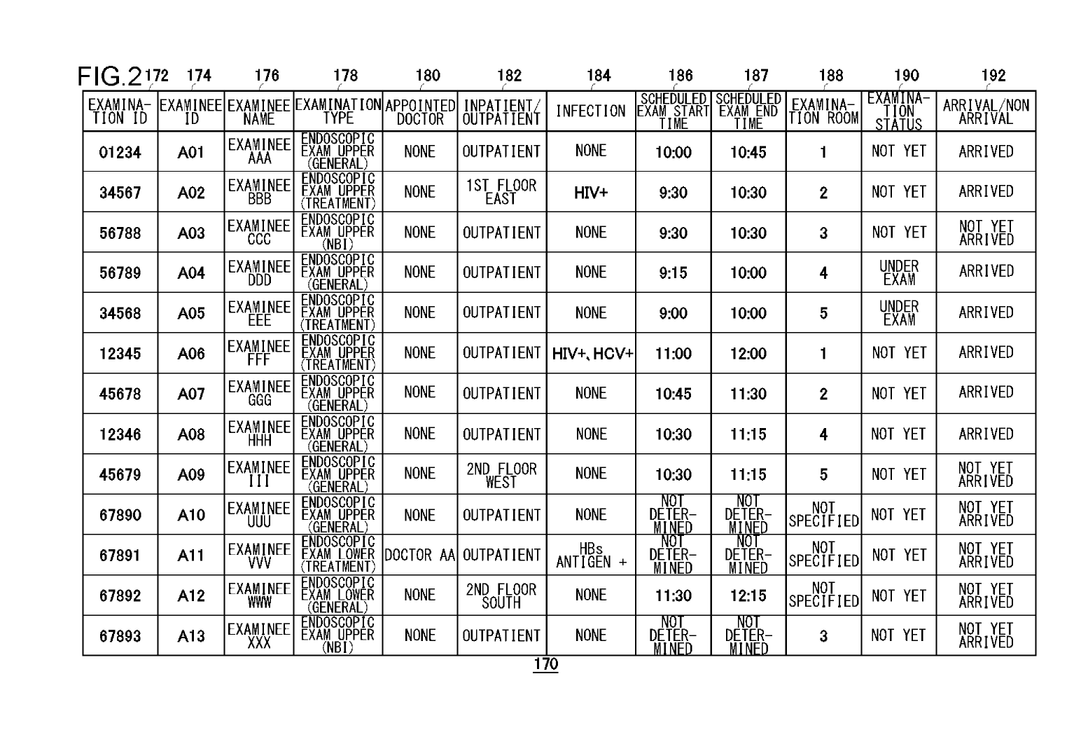

FIG. 2 shows an example of an examination information table 170 stored in the examination information storage 104. The examination information table 170 comprises an examination ID field 172, an examinee ID field 174, an examinee name field 176, an examination type field 178, an appointed doctor field 180, an inpatient/outpatient field 182, an infection field 184, a scheduled examination start time field 186, a scheduled examination end time field 187, an examination room field 188, an examination status field 190, and an arrival/non arrival field 192.

Examination order information acquired from the examination order storage 22 via the communication unit 24 of the medical information management server 20 and via the communication unit 102 of the schedule presentation device 100 is defined in the examination ID field 172, the examinee ID field 174, the examinee name field 176, the examination type field 178, the appointed doctor field 180, the inpatient/outpatient field 182, and the infection field 184 among the fields described above.

More specifically, examination identification information that uniquely identifies each examination is defined in the examination ID field 172. Examinee identification information that uniquely identifies each examinee is defined in the examinee ID field 174. The name of an examinee is defined in the examinee name field 176. The type of the examination is defined in the examination type field 178. The name of an appointed medical staff as described above in relation with the examination order item is defined in the appointed doctor field 180.

In case that an examinee undergoes an examination as an outpatient, defined in the inpatient/outpatient field 182 is “outpatient.” In case that an examinee stays in the hospital, defined in the inpatient/outpatient field 182 is a ward where the patient's room belongs to (e.g., an area and/or a floor where a hospital room of the examinee is located). In case the examinee is infected, the infection is written in the infection field 184.

If an examination order includes an appointed time of the examination, the appointed time is written in the scheduled examination start time field 186 as an initial value. In case that the examination information processing unit 110 assigns a scheduled examination start time to an examination, the assigned start time is written in the scheduled examination start time field 186. In the scheduled examination end time field 187, a scheduled examination end time, which is calculated by adding expected time required for the examination to the scheduled examination start time, is written. The “expected time required for the examination” refers to a time period predicted to be required for performing each examination, and if the predicted time period is specified in an examination order, the specified value is used as the expected time required for the examination. If the predicted time period is not specified in an examination order, for example a value read out from an required examination time storage (not shown), which relates a type of examination to typical required examination time and stores the examination type and the time, is used.

The examination room identification information of an examination room assigned to each examination is written in the examination room field 188. In this document, the scheduled examination start time, the scheduled examination end time, and information on the assigned examination room for each examination may also be referred to as “schedule information.”

The progression status of examination in each examination room acquired by the status update unit 160 is written in the examination status field 190. The arrival status of an examinee acquired by the status update unit 160 is written in the arrival/non arrival field 192. In this document, information such as the progression status of an examination, the arrival status of an examinee, or the like may also be referred to as “status information.”

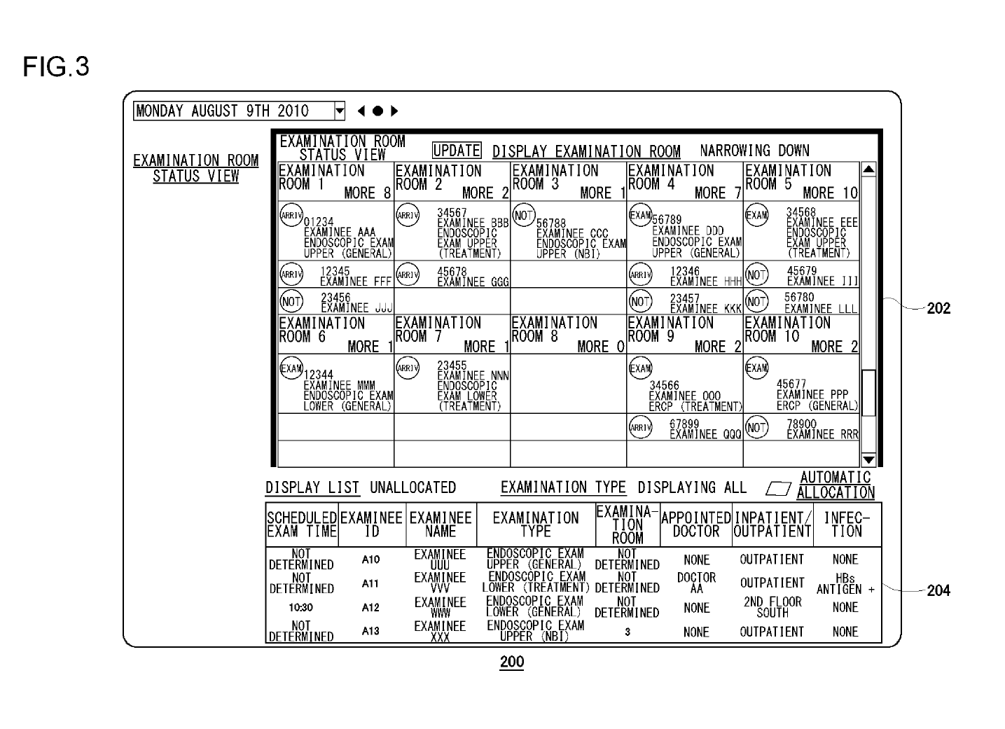

FIG. 3 shows an example of an examination schedule screen image 200 that the screen image generating unit 130 generates and that is displayed on a display device 50. The examination schedule screen image 200 includes a schedule display region 202 and an unallocated examination display region 204. In the schedule display region 202 shown in FIG. 3, rectangular blocks that respectively indicate an examination room are arranged in a matrix. In each rectangular block indicating an examination room, three scheduled examination displaying frames for displaying an examination allocated to the examination room are provided. The latest three examinations, selected from among examinations scheduled to be performed in the examination room and an examination being performed in the examination room, are displayed in the three frames respectively. The number of examinations that are allocated to each of the examination rooms, the number including an examination being performed, is indicated by displaying “8 more,” “2 more,” etc.

FIG. 3 shows an example where three scheduled examination displaying frames are provided for each examination room. However, a scheduled examination displaying frame number for each examination room, which is the number of scheduled examination displaying frames to be displayed for each examination room, may be configured so as to be appropriately defined depending on each medical facility, in accordance with the number of examination rooms, the size of a screen for displaying an examination schedule, the needs of a medical staff who manages examinations and the scheduling of the examinations, etc.

The scheduled examination displaying frame number may be defined differently for each examination room so that a different number of scheduled examination displaying frames can be displayed for each examination room. For example, in case that the typical required examination time for each examination room differs depending on the type of examinations performed in the examination room, or the like, the more number of scheduled examination displaying frames may be set for an examination room, of which the typical required examination time is shorter than an average, than that of the scheduled examination displaying frames for an examination room, of which the typical required examination time is longer than the average. Thereby, an appropriate number of scheduled examination displaying frames can be displayed in accordance with the situations of respective examination rooms, and a screen image can be presented to a user in a manner where an examination schedule for a plurality of examination rooms can be grasped intuitively.

In the example shown in FIG. 3, one of the three scheduled examination displaying frames that shows the latest examination is displayed larger than the other two scheduled examination displaying frames. Further, the more number of items of examination information are displayed in the scheduled examination displaying frame for the latest examination than the items of examination information for the other two scheduled examination displaying frames. Consequently, more information can be displayed for the latest examination, for which more information is required, in a limited area of the screen. The size of a scheduled examination displaying frame, the items of examination information to be displayed, or the like may be configured so as to be defined as appropriate in accordance with the number of examination rooms in the facility, the size of a display screen, the needs of a medical staff who manages examinations and the scheduling of the examinations, or the like. Consequently, more information can be displayed in a limited area of the screen while taking the situations of respective medical facilities into account.

Graphic symbols indicating respective examination rooms may be graphic symbols other than rectangles, such as, circles, polygons, etc. The graphic symbols may be shaped as a graphic symbol that reflects the actual shape of an examination room. The graphic symbols indicating respective examination rooms are not necessarily arranged in a matrix in a screen image. For example, the graphic symbols may be arranged in a manner that reflects the actual arrangement of the examination rooms. Consequently, respective examination rooms can be displayed in a manner that can be understood easily and intuitively for a person who manages a schedule, which reduces mistakes such as drawing up a schedule while switching examination rooms by mistake.

Examination information may be displayed as a mark. FIG. 3 shows an example where status information such as “the examinee has arrived,” “the examinee has not yet arrived,” “being under examination,” “the examination has completed,” etc. is displayed as a mark, which is for example a circled character/word/word part such as “ARRIV,” “NOT,” “EXAM,” “COMPL,” etc. Examination information may be displayed by the color of each graphic symbol that indicates an examination. Alternatively, the examination information may be displayed by a combination of: a) the color of each graphic symbol that indicates an examination; and b) a mark and/or text. Consequently, more information can be presented in a limited area of a screen in a manner that can be understood easily and intuitively.

Examination information of an examination to which a time and/or an examination room to perform the examination have not been assigned yet is displayed in the unallocated examination display region 204.

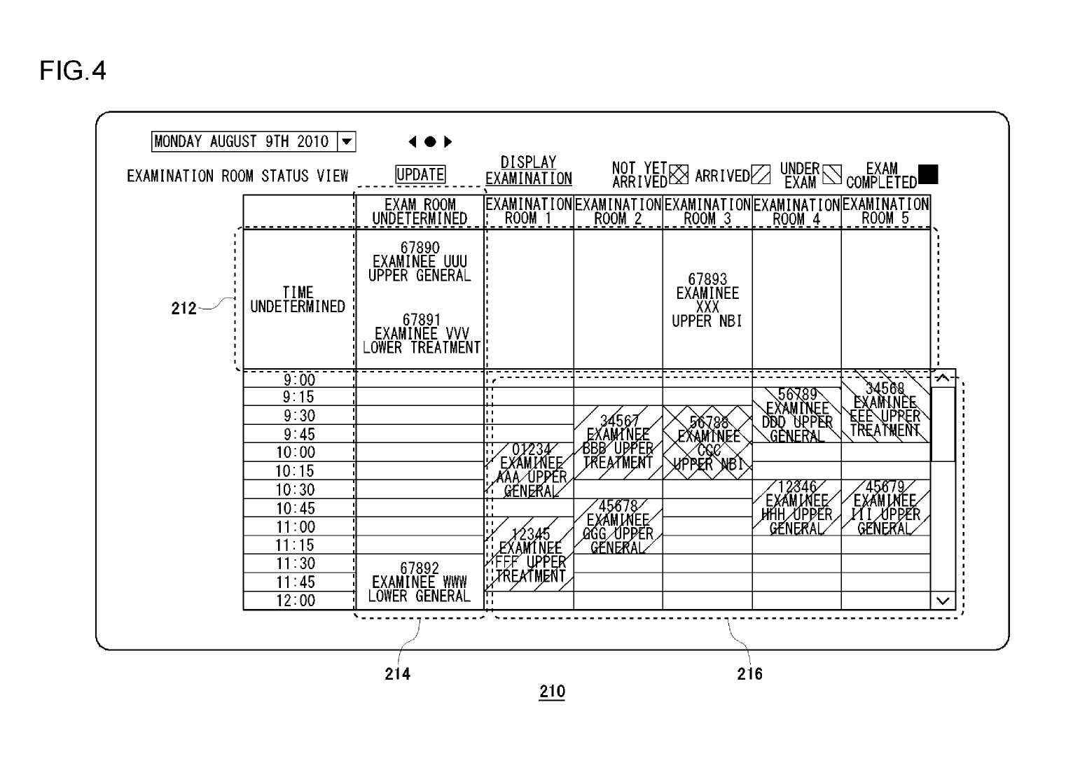

FIG. 4 shows an examination schedule screen image 210, which is another example of a screen image that the screen image generating unit 130 generates and that is displayed on the display device 50. The examination schedule screen image 210 includes an unallocated examination display region and a schedule display region 216. The unallocated examination display region includes a time undetermined field 212 for displaying examination information on an examination to which a time is not allocated, and an examination room undetermined field 214 for displaying examination information on an examination to which an examination room is not allocated. In the exemplary screen image shown in FIG. 4, the time undetermined field 212 and the examination room undetermined field 214 share a common area. In the common area, examination information on an examination to which neither time nor an examination room is allocated is displayed.

The schedule display region 216 shown in FIG. 4 is configured as a 2-dimensional matrix where the vertical axis indicates times and the horizontal axis indicates examination rooms. At a position that is specified by a time indicated by the vertical axis and that is specified by an examination room indicated by the horizontal axis, a graphic symbol of a rectangular box indicating an examination allocated to the time and the examination room is placed. The length along the time axis of each graphic symbol indicating an examination is determined so as to reflect an expected required time period for the examination. In FIG. 4, the size of each rectangular box that indicates an examination is determined so that the length of the sides along the time axis is proportional to the expected required time period for the examination. Graphic symbols indicating respective examinations may be graphic symbols other than rectangles, such as, circles, polygons, etc.

In each graphic symbol indicating an examination, examination information on the examination, such as, an examination ID, the name of an examinee, the type of the examination, or the like are displayed. Items of examination information to be displayed in the graphic symbols indicating respective examinations may be configured so as to be defined as appropriate in accordance with the number of examination rooms in the facility, the size of a display screen, the needs of a medical staff who manages examinations and the scheduling of the examinations, etc.

Although diagonal lines are used instead of colors in FIG. 4, the status information such as the progression status of an examination, the arrival status of an examinee, or the like may be displayed by changing the color of each graphic symbol indicating an examination. In this way, examination information such as status information or the like may be displayed as a mark, a color, or a combination thereof. Consequently, more information can be presented in a limited area of the screen in a manner that can be understood easily and intuitively.

The screen image generating unit 130 may generate both examination schedule screen images shown in FIG. 3 and FIG. 4. In this case, two types of screen images can be displayed switchably on the display device 50. Alternatively, if there are a plurality of display devices 50, the screen image generating unit 130 may be configured to transmit only one of the two types of screen images to a display device 50, the type determined as appropriate according to the property of each display device in advance. This enables examination information to be presented in a manner that can be understood easily and intuitively for a plurality of users having different point of views when checking an examination schedule (e.g., a medical staff who performs examinations, a person in charge of examination schedule management, an examinee, etc).

FIG. 1 will now again be referred to. The instruction unit 150 comprises an examination identification unit 152, a schedule frame specifying unit 154, and a change specifying unit 156.

If a user indicates one of examinations displayed on an image screen with a pointer (e.g., a cursor or the like) by using the controller unit 40, such as a mouse or the like, the examination identification unit 152 in the instruction unit 150 identifies the examination ID of the examination, and sends to the examination information processing unit 110 an instruction for an allocation process or the like while specifying the examination ID. For example, if a user indicates one of the rows in the unallocated examination display region 204 shown in FIG. 3, the examination identification unit 152 identifies the examination ID of the examination indicated by the row. Alternatively, if a user indicates one of the scheduled examination displaying frames, in which examination information is displayed, in the schedule display region 202 shown in FIG. 3, the examination identification unit 152 identifies the examination ID of the examination allocated to the scheduled examination displaying frame.

If a user indicates one of the unallocated examinations displayed in the time undetermined field 212 or in the examination room undetermined field 214 shown in FIG. 4, the examination identification unit 152 identifies the examination ID of the examination. If a user indicates one of the graphic symbols that indicate an examination and that are displayed in the schedule display region 216 shown in FIG. 4, the examination identification unit 152 identifies the examination ID of the examination indicated by the graphic symbol. Then the examination identification unit 152 passes the identified examination ID to the examination information processing unit 110.

If a user indicates a part of a schedule display region displayed on a screen with a pointer (e.g., a cursor or the like) by using the controller unit 40 (such as a mouse or the like), the schedule frame specifying unit 154 in the instruction unit 150 identifies the time and/or the examination room indicated by the indicated part of the schedule display region, and sends to the examination information processing unit 110 an instruction for an allocation process or the like while specifying the identified time and/or examination room.

For example, if a user indicates one of scheduled examination displaying frames, in which examination information is displayed, in the schedule display region 202 shown in FIG. 3, the schedule frame specifying unit 154 identifies the examination room indicated by the scheduled examination displaying frame, and the scheduled examination start time and/or the scheduled examination end time of the examination allocated to the scheduled examination displaying frame.

If a user indicates one of the scheduled examination displaying frames, in which examination information is not displayed, in the schedule display region 202 shown in FIG. 3, the schedule frame specifying unit 154 identifies a time point by a predetermined method for identifying a time. For example in case that an examination is allocated to the scheduled examination displaying frame right above the scheduled examination displaying frame indicated by the user (i.e., a frame temporally before the indicated frame), a scheduled examination start time indicated by the user may be identified as a time point calculated by adding a predetermined standard time period between examinations to the scheduled examination end time of the examination allocated to the frame right above the indicated frame, and a scheduled examination end time may be identified as a time point calculated by adding required examination time to the identified scheduled examination start time.

The predetermined standard time period between examinations refers to a typical time period recommended to spare between the scheduled end time of one examination and the scheduled start time of an examination consecutive to the one examination. That is, a time period required for tidying up equipment and preparing for the next examination, and/or a time period to be saved as insurance in case that the prior examination is prolonged. The predetermined standard time period between examinations may be defined by each medical facility as a desired value.

If a user indicates one of the cells that constitute the schedule display region 216 shown in FIG. 4, the schedule frame specifying unit 154 identifies the time point indicated by the horizontal axis and the examination room indicated by the vertical axis at the position of the indicated cell. When identifying a time, the schedule frame specifying unit 154 identifies a time point in accordance with a predetermined method for identifying a time point that associates a cell on the schedule display region 216 with a time. For example, a time point that is indicated by a cell pointed by a user may be identified as a scheduled examination start time, or may be identified as a scheduled examination end time. Alternatively, the scheduled examination start time may be defined as a time point calculated by subtracting a half of a required examination time period from the time point indicated by the cell that is pointed by the user, and a scheduled examination end time may be defined as a time point calculated by adding a half of the scheduled required examination time period to the time point that is indicated by the cell pointed by the user.

The method for identifying a time point may be selected by an operation input from a user. For example, if a user gives an instruction by an operation (e.g., by clicking the right button of a mouse, etc.), the schedule frame specifying unit 154 may instruct to display a window through which a user can enter a selection of a method for identifying a time point. Then the schedule frame specifying unit 154 may determine a method for identifying a time point by receiving an input selection from a user.

The schedule frame specifying unit 154 specifies and passes the identified time point and/or the identified examination room to the examination information processing unit 110 when transmitting an instruction for allocation process or the like to the examination information processing unit 110.

If a user instructs to deform a graphic symbol indicating an examination on a screen image through the controller unit 40 (such as a mouse or the like), the change specifying unit 156 identifies a time point and/or an examination room indicated by the deformed graphic symbol, and sends to the examination information processing unit 110 an instruction to change examination information while specifying the time point and/or the examination room after the change. For example, if a user indicates and drags along the time axis the lower side of the rectangular box, indicating an examination identified by ID56788 that is allocated to the examination room 3 in the schedule display region 216 on the examination schedule screen image 210 shown in FIG. 4, the change specifying unit 156 identifies a time point indicated by the end point of the drag in the schedule display region 216 as a scheduled end time. The change specifying unit 156 notifies the examination information processing unit 110 of the change of the end time of the examination identified by ID56788 while specifying the identified scheduled end time.

Upon receiving the notification from the change specifying unit 156, the examination information processing unit 110 changes examination information and stores the information into the examination information storage 104. The screen image generating unit 130 generates an examination schedule screen image 210 by reflecting the examination information after the change, the information having been updated by the examination information processing unit 110.

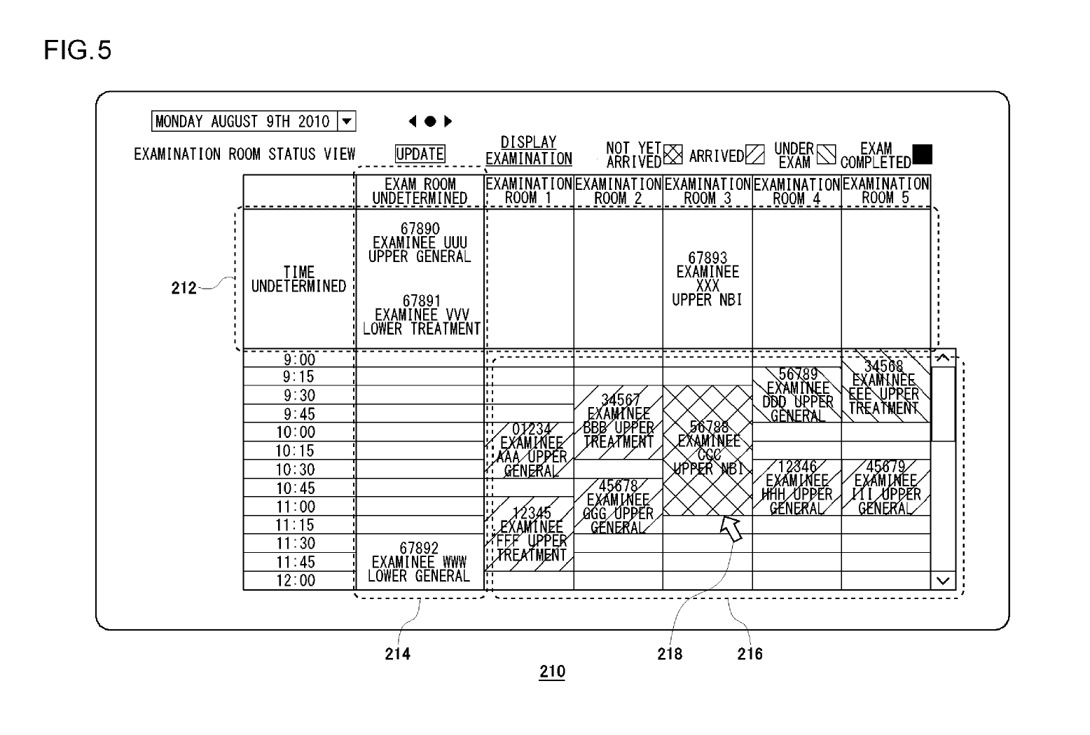

FIG. 5 shows an examination schedule screen image 210 in case a user indicates and drags by a pointer 218 the lower side of the rectangular box afterwards along the time axis in the examination schedule screen image 210, wherein the rectangular box indicates the examination identified by ID56788 that is allocated to the examination room 3. The rectangular box indicating the examination identified by ID56788 is deformed by the user's operation in the examination schedule screen image 210 as shown in FIG. 5, and information on the scheduled end time of the examination identified by ID56788 stored in the examination information storage 104 is changed accordingly.

Although FIG. 5 shows an example where a user indicates and drags the lower side of the rectangular box indicating the examination identified by ID56788 that is allocated to the examination room 3 in the schedule display region 216 on the examination schedule screen image 210 shown in FIG. 4, a similar process is used also in case that a user drags the upper side of a rectangular box indicating an examination.

That is, the change specifying unit 156 identifies a time point indicated by the end point of the drag in the schedule display region 216 as a scheduled examination start time. The change specifying unit 156 notifies the examination information processing unit 110 of the change of the scheduled examination start time of the examination identified by ID56788 while specifying the identified scheduled examination start time. Upon receiving the notification from the change specifying unit 156, the examination information processing unit 110 changes the examination information and stores the information into the examination information storage 104. The screen image generating unit 130 generates an examination schedule screen image 210 by reflecting the examination information after the change, the information having been updated by the examination information processing unit 110.

If a user performs a certain operation, for example if a user moves a graphic symbol that indicates an examination to another position, etc, so as to instruct a change of an examination room and/or an examination time that are allocated to the examination, the change specifying unit 156 determines whether or not to accept the change. Upon determining that the change can be accepted, the change specifying unit 156 instructs the examination information processing unit 110 to change the examination room and/or the examination time.

More specifically, the change specifying unit 156 identifies an examination ID indicated by a graphic symbol or a section pointed by the user, and reads the progression status of the examination from the examination information storage 104. If the progression status of the examination is not “under examination,” nor “examination completed,” the change specifying unit 156 determines that the change instruction can be accepted. In this case, the change specifying unit 156 further identifies a time point and/or an examination room that the user specifies by an operation (e.g., moving the graphic symbol on a screen image, etc.) and sends an instruction to change the examination time and/or the examination room to the examination information processing unit 110. On the other hand, if the progression status of the examination that is read out is “under examination,” or “examination completed,” the change specifying unit 156 determines that the change instruction can not be accepted, and notifies an impossible display generating unit 138 (which will be described later) in the screen image generating unit 130 thereof. In case that only a change of examination time is instructed, the change specifying unit 156 may accept the instruction to change the examination time even if the progression status of the examination that is read out is “under examination.”

Thereafter, an allocation process by the examination information processing unit 110 and/or a generation process by the impossible display generating unit 138 for generating an impossible display indicating that a change is not allowed are performed in a similar manner as that of a process for allocating an examination room and/or a time to an unallocated examination, which will be described later. This allows a user to instruct to change a schedule with an easy-to-understand and intuitive operation.

FIG. 1 will now again be referred to. The status update unit 160 comprises: an examination status update unit 162 that acquires the progression information of an examination and updates examination information; and a reception status update unit 164 that acquires information on the arrival of an examinee and updates examination information. The examination status update unit 162 acquires an examination status (e.g., “not yet started,” “under examination,” “examination completed,” etc.) for each examination via the communication unit 102 from an examination device (not shown) installed in each examination room, and stores the acquired examination status in the examination status field 190 of the examination information table 170.

The progression status of an examination may be acquired by allowing the status update unit 160 to transmit an inquiry to each examination device at predetermined time intervals, or may be acquired by receiving a notification at appropriate timing from an examination device, for example when an examination is started, when an examination is completed, etc.

The reception status update unit 164 acquires via the communication unit 102 reception information on each examinee, which is input via an input terminal (not shown) installed at a reception of an examination department or the like. For example, the reception information of an examinee may be input in the following manners: a) an examinee inputs his/her reception information by allowing his/her patient ID card to be read by an automatic reception apparatus by himself/herself; or b) a receptionist inputs the reception information of an examinee by checking a patient ID card that the examinee presents at the reception, and by operating a controller unit (e.g., a keyboard, or the like) of a reception terminal. The reception status update unit 164 may acquire reception information by sending an inquiry to a reception terminal or the like at predetermined time intervals, or may acquire reception information by receiving a notification from a reception terminal or the like when the reception of an examinee is input.

Based on the acquired reception information, the reception status update unit 164 stores the arrival status of an examinee in the examination information table 170. The examination information table 170 of FIG. 2 shows an example where the arrival status is defined as “arrived” if the examinee has already checked in, and defined as “not yet arrived” if the examinee has not checked in yet in the arrival/non arrival field 192 of the examination information table 170.

In this manner, the status update unit 160 updates status information of each examination on an as needed basis, and the screen image generating unit 130 generates a screen image where the update is reflected, and allows the screen image to be displayed on the display device 50. Consequently, a person in charge of schedule management can review the progression statuses of examinations, the arrival statuses of examinees, etc, in almost real time. Therefore, a necessity to change an examination schedule can be detected at an early stage, and the examination schedule can be changed in response to situations in a flexible manner. Thus, resources such as an examination facility, human resources, or the like can be utilized effectively.

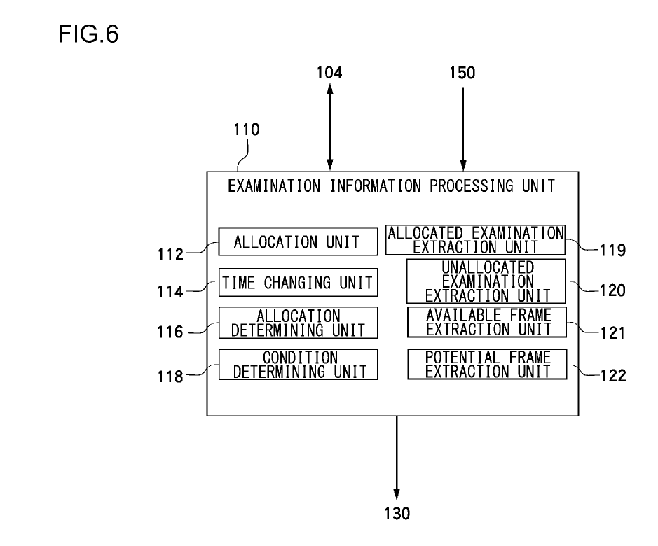

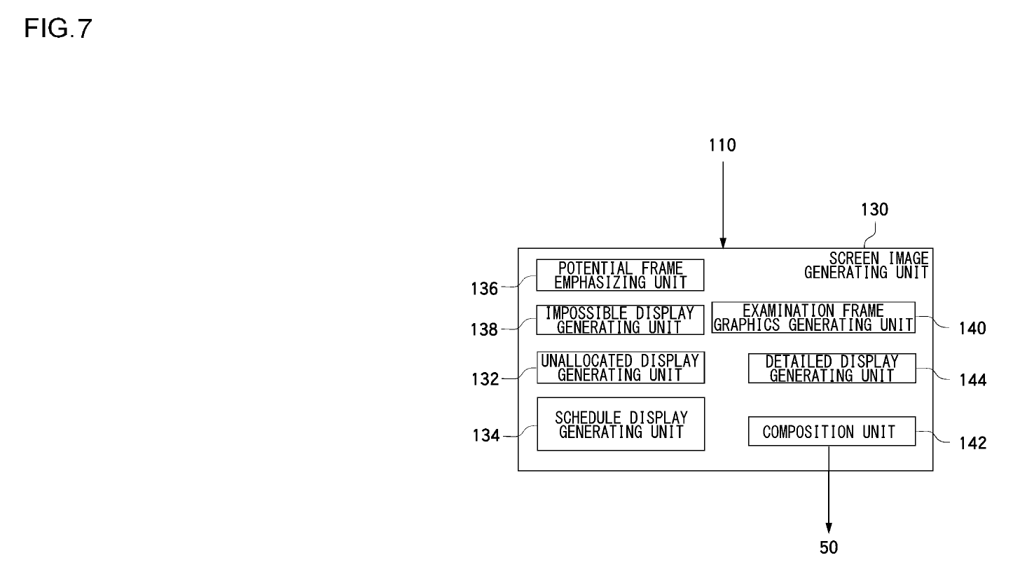

By referring to FIGS. 6 and 7, an explanation will be given below on the configuration of the examination information processing unit 110 and the screen image generating unit 130 of the schedule presentation device 100 shown in FIG. 1.

FIG. 6 shows a configuration of the examination information processing unit 110 in the schedule presentation device 100 shown in FIG. 1. The examination information processing unit 110 comprises an allocation unit 112, a time changing unit 114, an allocation determining unit 116, a condition determining unit 118, an unallocated examination extraction unit 120, an allocated examination extraction unit 119, and a potential frame extraction unit 122. The allocation unit 112 allocates an examination time and an examination room to each examination. The time changing unit 114 changes a time and/or an examination room allocated to an examination and stores the information thereof in the examination information storage 104 on the basis of identification by the change specifying unit 156. The allocation determining unit 116 determines whether or not a specified examination can be assigned to a specified time slot and to a specified examination room. The condition determining unit 118 determines whether or not a specification condition specified by a user is satisfied with respect to an unallocated examination. The unallocated examination extraction unit 120 extracts an examination to which a time or an examination room is not allocated. The allocated examination extraction unit 119 extracts an examination to which an examination room and a time are allocated. The potential frame extraction unit 122 extracts an examination room and a time to which a specified examination can be allocated.

FIG. 7 shows a configuration of the screen image generating unit 130 in the schedule presentation device 100 shown in FIG. 1. The screen image generating unit 130 comprises an unallocated display generating unit 132, a schedule display generating unit 134, a potential frame emphasizing unit 136, an impossible display generating unit 138, an examination frame graphics generating unit 140, a composition unit 142, and a detailed display generating unit 144. The unallocated display generating unit 132 generates data to be displayed in an unallocated examination display region. The schedule display generating unit 134 generates data to be displayed in a schedule display region. When an examination is specified, the potential frame emphasizing unit 136 generates data for displaying with an emphasis a time window and an examination room, to which the specified examination can be allocated. The impossible display generating unit 138 generates data for displaying that a specified allocation can not be allowed. The examination frame graphics generating unit 140 generates data for displaying a graphic symbol that can serve as a reference when allocating a specified examination. The composition unit 142 combines data so as to generate an examination schedule screen image. The detailed display generating unit 144 generates data for displaying detailed examination information for a particular examination in accordance with a user's specification.

As explained above regarding FIGS. 3 and 4, an examination schedule screen image includes a schedule display region and an unallocated examination display region. The unallocated examination extraction unit 120 in the examination information processing unit 110 extracts unallocated examination information, which is a list of examinations to which an execution time or an examination room is not allocated, from examination information stored in the examination information storage 104. For example, the unallocated examination extraction unit 120 refers to a scheduled examination date field (not shown), the scheduled examination start time field 186, the scheduled examination end time field 187, and the examination room field 188 of the examination information table 170. The unallocated examination extraction unit 120 extracts an examination which is booked for a day subject to scheduling and for which at least one of: the scheduled examination start time; the scheduled examination end time; or the examination room is written as “undetermined,” “not specified,” etc. The unallocated examination extraction unit 120 passes the extracted unallocated examination information to the screen image generating unit 130. The unallocated display generating unit 132 in the screen image generating unit 130 generates data for displaying the extracted unallocated examination information, which is acquired from the unallocated examination extraction unit 120, in the unallocated examination display region 204.

In this process, the unallocated display generating unit 132 may divide examinations included in the unallocated examination information into three groups so as to generates data for displaying the unallocated examination information in the unallocated examination display region 204. The three groups may be a group of examinations to which an execution time is not allocated, a group of examinations to which an examination room is not allocated, and a group of examinations to which neither an execution time nor an examination room is allocated. More specifically, if the unallocated examination extraction unit 120 extracts one or more examinations to which an examination room is not allocated, the unallocated display generating unit 132 generates data for displaying the examinations to which an examination room is not allocated in the examination room undetermined field 214. If the unallocated examination extraction unit 120 extracts one or more examinations to which a time is not allocated, the unallocated display generating unit 132 generates data for displaying the examinations to which a time is not allocated in the time undetermined field 212.

For an examination to which only an execution time is allocated, the unallocated display generating unit 132 may create data for displaying the examination so that the allocated execution time is indicated by a position for displaying the examination in the examination room undetermined field 214 as shown, for example, in FIG. 4. In this process, examinations to which a same examination execution time point is allocated or examinations of which allocated examination times overlap each other are arranged in predetermined order and displayed in a section that indicates the allocated execution time in the examination room undetermined field 214. The predetermined order may be order of the date and time of the issuance of examination orders. In case that the examination execution times allocated to the examinations overlap each other but the start times and/or the end times thereof differ from each other, the predetermined order may be order of examination start times or order of examination end times.

In a similar manner, for an examination to which only an examination room is allocated, the unallocated display generating unit 132 may create data for displaying the examination so that the allocated examination room is indicated by a position for displaying the examination in the time undetermined field 212. For an examination to which neither an examination room nor a time is allocated, the unallocated display generating unit 132 may create data for displaying the examination in the common area shared by the time undetermined field 212 and the examination room undetermined field 214.

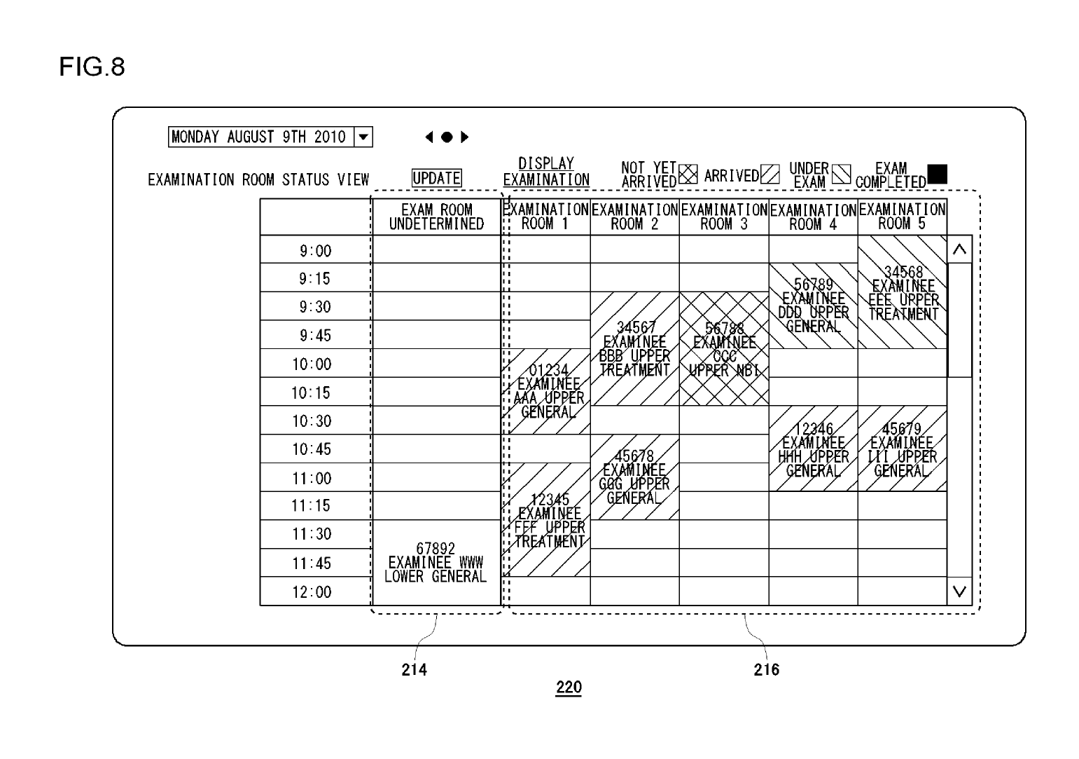

If the unallocated examination extraction unit 120 determines that an examination to which a time is not allocated is not included in examination information, the unallocated display generating unit 132 may determine not to display the time undetermined field 212. FIG. 8 shows an example of an examination schedule screen image 220 in which the time undetermined field 212 is not displayed in case that an examination to which a time is not assigned is not included in examination information. Although the examination schedule screen image 220 shown in FIG. 8 is displayed in a similar format as that of the examination schedule screen image 210 shown in FIG. 4, the time undetermined field 212 is not displayed because an examination to which a time is not allocated is not included in the examination information.

In a similar manner, if the unallocated examination extraction unit 120 determines that an examination to which an examination room is not allocated is not included in examination information, the unallocated display generating unit 132 may determine not to display the examination room undetermined field 214. If the unallocated examination extraction unit 120 determines that neither an examination to which an examination room is not allocated nor an examination to which a time is not allocated is included in examination information, the unallocated display generating unit 132 may determine not to display the unallocated examination display region per se.

The allocated examination extraction unit 119 in the examination information processing unit 110 extracts allocated examination information, which is a list of examinations to which an execution time and an examination room are allocated, from examination information stored in the examination information storage 104, and passes the allocated examination information to the screen image generating unit 130. The schedule display generating unit 134 in the screen image generating unit 130 generates data for displaying the allocated examination information, which is extracted by the allocated examination extraction unit 119, in the schedule display region.

In this process, the schedule display generating unit 134 may create data for displaying the schedule display region by arranging graphic symbols that represent respective examination rooms as shown in FIG. 3. In this case, the schedule display generating unit 134 generates data for providing in each graphic symbol, which represents an examination room, a plurality of scheduled examination displaying frames to display one or more examinations allocated to the examination room, and data for displaying in respective scheduled examination displaying frames examination information on one or more examinations that are scheduled to be performed first among the examinations scheduled to be performed in the examination room.

The schedule display generating unit 134 may create data for displaying the schedule display region as a 2-dimensional matrix where one axis indicates times and the other axis indicates examination rooms as shown in FIG. 4. In this case, the schedule display generating unit 134 generates data for displaying one graphic symbol on a portion, to which one examination is allocated, of the schedule display region.

In order do display information on a plurality of examinations in an easy-to-view manner, the number of items of examination information to be displayed in the schedule display region for each examination will be limited as shown in FIGS. 3 and 4. Therefore more detailed information for each examination allocated to the schedule display region may be displayed, for example by means of a hint display or the like. If a user points to a portion to which one examination is allocated in a schedule display region by using the controller unit 40, the examination identification unit 152 identifies the examination ID of the examination and passes the ID to the detailed display generating unit 144 in the screen image generating unit 130. Based on the examination ID received from the examination identification unit 152, the detailed display generating unit 144 reads the examination information thereof from the examination information storage 104, and generates data for displaying detailed information on the identified examination.

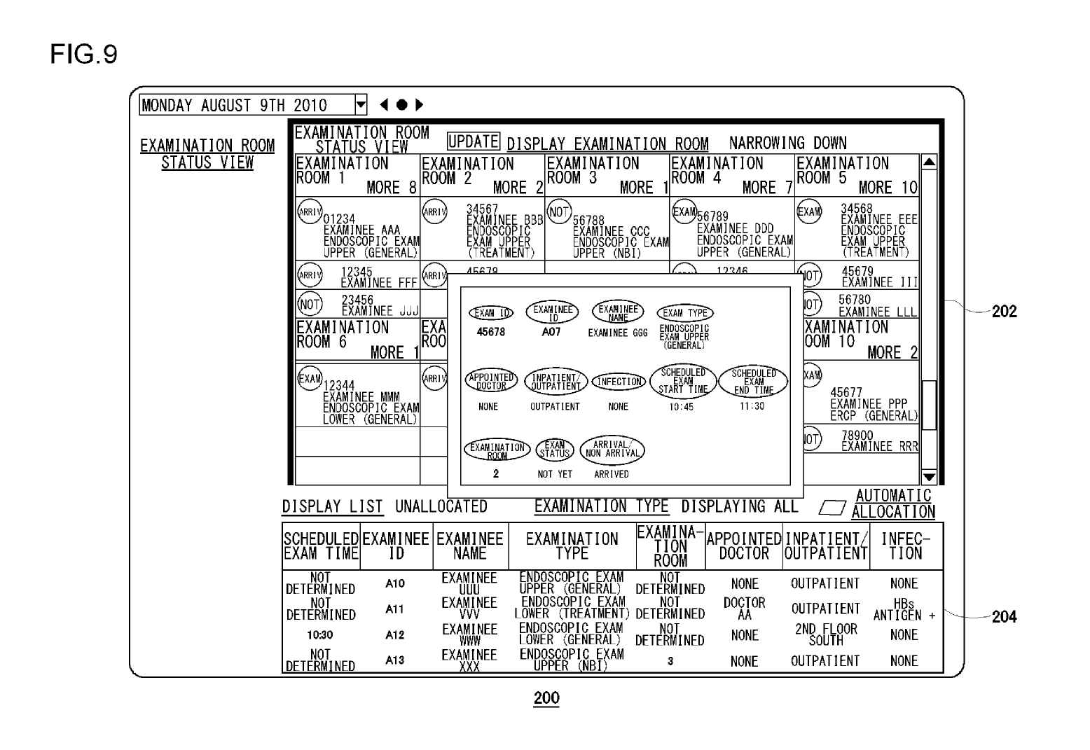

FIG. 9 shows an example of a hint display that is displayed when a user specifies, by using the controller unit 40 (e.g., by mousing over, etc.), the examination of the examination ID “45678” in the examination schedule screen image 200 shown in FIG. 3. In this manner, a more detailed explanation on each examination can be displayed upon a user's instruction. Consequently, both requirements that schedules for a plurality of examination rooms be over-viewed in a limited display space and that detailed information be displayed for an individual examination can be satisfied.

The composition unit 142 in the screen image generating unit 130 combines data generated by the unallocated display generating unit 132 and data generated by the schedule display generating unit 134, generates an examination schedule screen image shown in FIG. 3 or FIG. 4, and allows the display device 50 to display the examination schedule screen image.

A user can also allocate a time and/or an examination room to an examination while reviewing an examination schedule screen image that the schedule presentation device 100 allows the display device 50 to display. For example, by using a pointing device (e.g., a mouth or the like), a user selects one of examinations displayed in the unallocated examination display region. By dragging the selected examination, the user can move the examination to a position where a time and an examination room, to which the selected examination will preferably be allocated, are displayed. Then the user drops the examination. Consequently, the user can allocate the time and the examination room to the examination. Alternatively, the schedule presentation device 100 may be configured so that a user can make allocation in the following manner. That is, a user first selects one of examinations displayed in the unallocated examination display region. The user clicks the right button of a mouse, whereby a list of times and examination rooms to which the selected examination can be allocated are displayed on a separate window. Then the user selects and inputs one of the times and/or the examination rooms, so that the examination can be allocated to the selected time and/or to the examination room.

More specifically, if a user points to one of examinations displayed in the unallocated examination display region by using the controller unit 40, the examination identification unit 152 identifies the examination ID of the pointed examination and passes the ID to the examination information processing unit 110 as described above.

In this process, in case that the schedule display region 216 is configured in a similar manner as that of the examination schedule screen image 210 shown in FIG. 4, i.e., in case that one of the axes of the schedule display region 216 indicates times and an allocated examination is displayed as an examination frame graphic symbol that reflects the required examination time period of the examination, an examination may be displayed as an examination frame graphic symbol when a user designates the examination as an examination to be allocated.

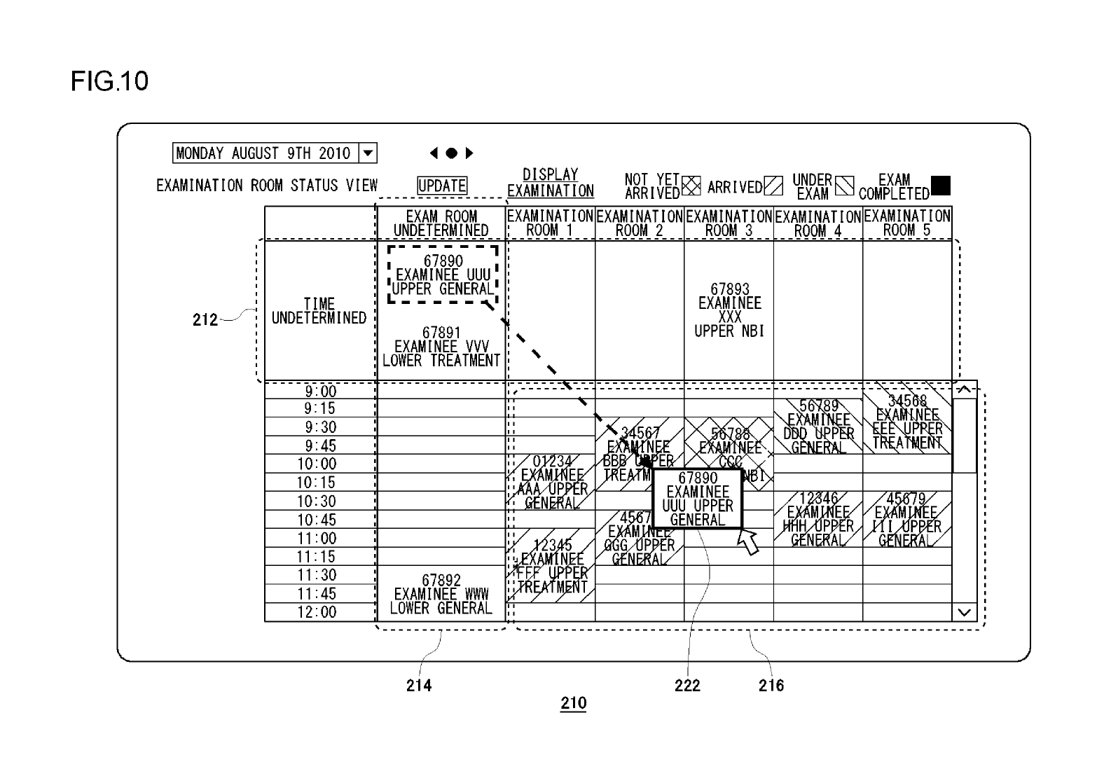

FIG. 10 shows an example of an examination frame graphic symbol that is displayed when a user points to one of the unallocated examinations in the examination schedule screen image 210 shown in FIG. 4. FIG. 10 shows a state where a user points to the examination of the examination ID “67890” among unallocated examinations displayed in the common area shared by the time undetermined field 212 and the examination room undetermined field 214, and where the user is in the middle of moving the examination by a drag operation.

The examination identification unit 152 identifies the examination ID “67890” of the examination pointed by the user, reads the examination type thereof from the examination information storage 104, and reads a typical time period usually required for that type of examination from the required examination time storage (not shown). The examination frame graphics generating unit 140 in the screen image generating unit 130 generates examination frame graphic information for displaying an examination frame graphic symbol 222 indicating the examination identified by the examination ID “67890” while reflecting the read required examination time period. FIG. 4 shows an example where the examination frame graphic symbol 222 indicating that the time period required for the examination of the examination ID “67890” is about 45 minutes is displayed as if the examination frame graphic symbol 222 moves following a cursor.

Displaying an examination frame graphic symbol 222 allows a user, upon designating an examination to be allocated, to recognize the required time for the examination. Consequently, the user can grasp intuitively to which examination room and to which time window the examination can be allocated as if fitting a piece of a puzzle.

An available frame extraction unit 121 in the examination information processing unit 110 extracts from the examination information table 170 frame availability information that indicates one or more available time frames for each examination room. The potential frame extraction unit 122 in the examination information processing unit 110 refers to the examination information table 170 and generates allocation requirements with regard to the examination of an examination ID identified by the examination identification unit 152. The potential frame extraction unit 122 further extracts one or more available frames that satisfy the allocation requirements from the available time frames included in the frame availability information extracted by the available frame extraction unit 121, by which, the potential frame extraction unit 122 extracts potential allocation information that indicates one or more examination rooms and times that can be allocated to the examination.

The allocation requirements refer to requirements that should be taken into account when allocating an examination room and a time to each examination. For example, in case that a scheduled time point read from an examination order is defined in the scheduled examination start time field 186 in the examination information table 170, one of the requirements will be that the examination start time be allocated to a time point that is at or after the scheduled time point and that is as close as possible to the scheduled time point. In case that a medical staff who takes charge of a certain examination is defined in the appointed doctor field 180, a time when the appointed medical staff performs examinations, and an examination room where the medical staff performs examinations will be set as requirements. In case an infection is written in the infection field 184, allocation of an examination room that is far away from an examination room for normal examinees will be set as a requirement. In case that required examination time is specified, and/or required examination time is determined by the type of examination defined in the examination type field 178, the required examination time will also be set as a requirement.

The potential frame emphasizing unit 136 in the screen image generating unit 130 generates data for displaying with an emphasis an area that indicates an allocatable examination room and an allocatable time (herein after also referred to as a “potential frame”) in the schedule display region on the basis of potential allocation information extracted by the potential frame extraction unit 122. The potential frame emphasizing unit 136 generates data for displaying an area that indicates an examination room and a time to which the specified examination can be allocated in the schedule display region in a manner where the area is more noticeable than the other areas.

For example, the potential frame emphasizing unit 136 generates data for displaying information on an examination room and a time to which the examination can be allocated while enlarging an potential frame, changing the color of the frame, allowing the frame to blink, marking the frame, popping up another window, etc. This allows a user to easily grasp an allocatable examination room and an allocatable time window for each examination.

If a user points, by using the controller unit 40, to a time and an examination room, to which to allocate a specified examination, in the schedule display region or in another window that is displayed as a pop-up or the like, the schedule frame specifying unit 154 identifies the time and the examination room as described above and passes the time and the examination room to the allocation determining unit 116 in the examination information processing unit 110.

The allocation determining unit 116 determines whether or not the examination, which the user has selected and input and the examination identification unit 152 has identified, to the time and the examination room specified by the schedule frame specifying unit 154. This is to prevent an examination from being allocated to an examination room and/or to a time window in which the examination can not be performed as a result of an operational mistake of a user.

The allocation determining unit 116 first refers to the examination information table 170 and generates allocation requirements with regard to the examination of an examination ID identified by the examination identification unit 152. The allocation requirements in this case include a requirement that an examination room specified by the schedule frame specifying unit 154 be available at a time specified by the schedule frame specifying unit 154. In case that allocation requirements have already been generated by the potential frame extraction unit 122, the allocation determining unit 116 may use the requirements. Next, the allocation determining unit 116 determines whether or not the time and the examination room specified by the schedule frame specifying unit 154 satisfy the allocation requirements for the examination of the examination ID identified by the examination identification unit 152.

Upon determining that the allocation requirements are satisfied, the allocation determining unit 116 notifies the allocation unit 112 thereof, and upon determining that the allocation requirements are not satisfied (i.e., non-allocatable), the allocation determining unit 116 notifies the impossible display generating unit 138 in the screen image generating unit 130 thereof.

Examples of cases where the allocation requirements are not satisfied include: a case where a specified frame is not available (for example, a part of or all of the time specified by the schedule frame specifying unit 154 for the examination room specified by the schedule frame specifying unit 154 has been already registered for another examination); a case where the difference between a scheduled time point specified by an examination order and a time point specified by the schedule frame specifying unit 154 falls out of an acceptable range; etc. In case a medical staff who performs an examination is appointed, the allocation may also be determined to be impossible if a time specified by the schedule frame specifying unit 154 does not fall in the working hours of the staff, or if the staff has already registered as a person in charge of another examination for a part of or all of the specified time. The allocation may also be determined to be impossible if an examination of an examinee who is registered as infected is designated to be allocated to an examination room, an examination time, or a medical staff other than an examination room, a time, or a medical staff that are specified in advance for infected examinees.

If the allocation determining unit 116 determines that allocation is not allowed, the impossible display generating unit 138 generates data for displaying that the allocation is not allowed. For example, the impossible display generating unit 138 may generate data for popping up a separate window and for displaying thereon a message that a specified examination cannot be assigned to a specified time and a specified examination room. In this process, the impossible display generating unit 138 may allow a requirement that is not satisfied to be displayed.

The impossible display generating unit 138 may generate data for displaying with a message a button or the like for confirming the intention of a user so that the allocation can be made in case the user desires the allocation even if the allocation is not allowed. If the user acknowledges a warning and instructs the allocation by using the controller unit 40, the allocation unit 112 in the examination information processing unit 110 performs an allocation process, which will be described later. This prevents a mistake resulted from an operating error made by a user, and at the same time, allows flexible schedule management that can handle cases such as fitting an urgent examination in an available time window that is too narrow to schedule the examination in accordance with a usual standard.

Alternatively, the impossible display generating unit 138 may display, if a user drags an examination and drops the examination at a position that indicates a certain time and a certain examination room in the schedule display region, the examination as if it is bounced back from the position in order to indicate that the allocation is not allowed. That is, if a user selects one of examinations displayed in the unallocated examination display region by using a pointing device, moves the selected examination by dragging to a time and an examination room to which the selected examination is to be allocated, and tries to drop the examination, the impossible display generating unit 138 may display moving images showing that the examination can not be dropped at the position of the cursor and is moved back to the original position.

In addition to displaying that the allocation is not allowed, a warning sound such as a beep tone or the like may be output through a speaker or the like (not shown) so as to call attention of a user. Thereby, a message informing that allocation instructed by a user is not allowed according to a usual standard can be conveyed to the user certainly.

In this manner, a message informing that allocation can not be allowed is displayed. Consequently, mistakes (such as allocating an examination to an examination room and/or to a time window in which the examination can not be performed), which may occur in case that displaying an allocatable area with an emphasis as described above is not adopted, or may occur as a result of an operational mistake of a user even in case that displaying an allocatable area with an emphasis is adopted, can be prevented.

The allocation unit 112 in the examination information processing unit 110 allocates the examination, which the examination identification unit 152 has identified, to the time and the examination room specified by the schedule frame specifying unit 154, and stores the allocation information into the examination information storage 104. That is, the allocation unit 112 stores an examination room specified by the schedule frame specifying unit 154 in the examination room field 188 in the examination information table 170, and stores a scheduled examination start time and/or a scheduled examination end time specified by the schedule frame specifying unit 154 in the scheduled examination start time field 186 and/or in the scheduled examination end time field 187 respectively in the examination information table 170 for the examination that the examination identification unit 152 has specified.

The unallocated display generating unit 132 and the schedule display generating unit 134 in the screen image generating unit 130 generate screen image data by reflecting information of the examination assigned by the allocation unit 112. More specifically, the unallocated display generating unit 132 generates data for displaying unallocated examination information on the unallocated examination display region in an examination schedule screen image. In the unallocated examination information, an examination to which the allocation unit 112 has assigned a time and an examination room is excluded from examinations to be displayed. The schedule display generating unit 134 generates data for displaying allocated examination information on the schedule display region in the examination schedule screen image, while including examinations, to which the allocation unit 112 has assigned a time and an examination room, in the allocated examination information.

The composition unit 142 in the screen image generating unit 130 synthesizes data generated by the unallocated display generating unit 132 and data generated by the schedule display generating unit 134, generates an examination schedule screen image, and allows the display device 50 to display the examination schedule screen image.

As described above, the schedule presentation device 100 according to the exemplary embodiment can also automatically assign one or more unallocated examinations to an available examination room and to an available time in accordance with a condition specified by a user.

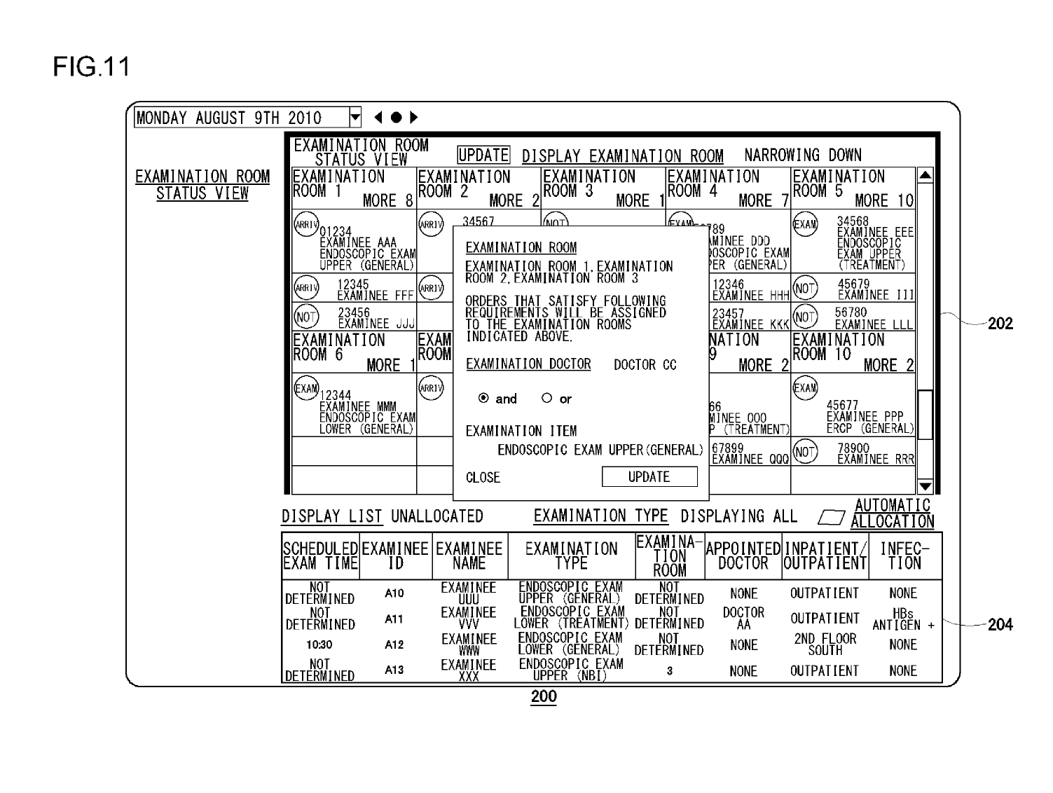

FIG. 11 shows a screen image for allowing a user to input a specification condition that specifies which unallocated examination is to be allocated automatically in case of allocating an examination room and/or an examination time to an unallocated examination automatically. The specification condition is a condition for narrowing unallocated examinations down to unallocated examinations to which an examination room and a time should be allocated. In the example shown in FIG. 11, a user specifies to assign unallocated examinations that can be allocated as an endoscopic examination for upper digestive tract (general) performed in examination rooms 1, 2, or 3 by a doctor CC.

The condition determining unit 118 in the examination information processing unit 110 determines whether or not a specified condition is satisfied for each examination extracted by the unallocated examination extraction unit 120. For example, among the unallocated examinations displayed in the unallocated examination display region 204 shown in the example of FIG. 11, the examination displayed at the top indicates “doctor CC” as an appointed doctor, and “endoscopic examination for upper digestive tract (general)” as the type of the examination. Thus the examination satisfies the conditions specified by the user.

The potential frame extraction unit 122 in the examination information processing unit 110 extracts potential allocation information for an unallocated examination determined to satisfy the specification conditions by the condition determining unit 118. The potential allocation information indicates an examination room and a time that can be allocated to an unallocated examination. Then the allocation unit 112 in the examination information processing unit 110 assigns an allocatable examination room and an allocatable time extracted by the potential frame extraction unit 122 to the examination determined by the condition determining unit 118 to satisfy the specification conditions, and stores the allocation information in the examination information storage 104. If there are a plurality of allocatable frames of an examination room and a time, the allocation unit 112 allocates the examination for example to the frame earliest in time.

In this manner, by enabling the automatic allocation, a user (e.g., a person in charge of planning a schedule, or the like) does not have to make a schedule by himself/herself from scratch, which is a troublesome task. Thus the burden on the user is reduced. By allowing a user to specify a condition in case of automatic allocation, an examination schedule can be determined suitably to complex circumstances, for example a case where combinations of an examination room and examination equipment installed in each examination room, and/or combinations of an examination room and a doctor or the like who performs examinations in each examination room differ from day to day or differ depending on the time of day (am or pm) even in the same day.

The elements shown in FIGS. 1, 6, and 7 are implemented by an element device (e.g., a CPU of a computer or the like) and/or machinery and equipment in terms of hardware components, and a computer program, or the like in terms of software components. FIGS. 1, 6, and 7 depict functional blocks implemented by cooperation of these components. Therefore, it will be obvious to those skilled in the art that the functional blocks may be implemented in a variety of ways, by hardware only, software only, or a combination thereof.

An exemplary explanation on the operation of the device with the aforementioned configuration will be given below. First, in the night just before examinations or in the morning of the examinations after most of the examination orders for the day are made, a user (e.g., a person in charge of examination schedule management, or the like) inputs specification conditions for allocating the examinations into the schedule presentation device 100. As described above, the condition determining unit 118 in the examination information processing unit 110 determines whether or not to perform allocation for each of unallocated examinations. From available examination rooms and available time frames extracted by the available frame extraction unit 121, the potential frame extraction unit 122 extracts an examination room and a time frame to which an examination subject to allocation can be allocated. And the allocation unit 112 allocates an examination time and an examination room to an examination subject to an allocation process. The screen image generating unit 130 generates data for presenting to a user a schedule updated according to the allocation, and allows the display device to display the schedule.

By repeating the procedure described above while changing the specification conditions, or by setting the specification conditions loosely in advance, an examination room and an examination time can be allocated to all of the unallocated examinations.

On the day of an examination, the screen image generating unit 130 in the schedule presentation device 100 generates data for displaying an examination schedule screen image 200 that reflects a cancellation of an examination occurred on the date of the examination, an urgent examination order, the arrival status of examinees, the progression status of examinations, or the like on an as needed basis, and allows the display device 50 to display the examination schedule screen image 200. Since information regarding cases to which an examination room and/or a time frame is not allocated is also displayed in the same examination schedule screen image, a user can obtain information on an unallocated examination promptly.

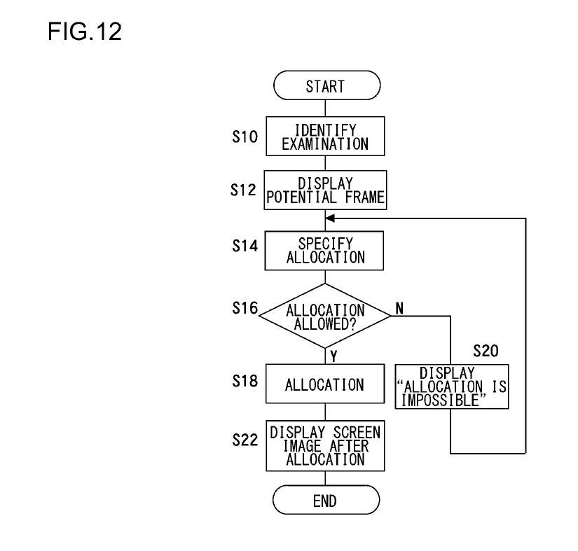

A user allocates an examination room and an examination time to each unallocated examination automatically, or by checking one by one by himself/herself. FIG. 12 shows a flowchart indicating a procedure where a user assigns one of unallocated examinations to an available examination room and to an available time by using the schedule presentation device 100 shown in FIG. 1.

First, the user selects one of unallocated examinations in an unallocated examination display region in an examination schedule screen image, and inputs the selected examination. The examination identification unit 152 identifies the ID of the input examination, accordingly (S10). The potential frame extraction unit 122 generates allocation requirements for the identified examination, and extracts an examination room and a time frame that satisfies the allocation requirements from available examination rooms and available time frames extracted by the available frame extraction unit 121. The potential frame emphasizing unit 136 generates data for displaying with an emphasis one or more frames of an examination room and a time to which the examination can be allocated. The potential frame emphasizing unit 136 allows the display device 50 to display an examination schedule screen image where one or more frames indicating an examination room and a time to which the examination can be allocated are displayed with an emphasis (S12), accordingly.

A user views the examination schedule screen image, selects a frame to which the indicated unallocated examination is to be allocated, and inputs the selection (S14), and the allocation determining unit 116 determines whether or not to allow the allocation of the specified examination room and the specified examination time to the examination specified by the user, accordingly (S16). If the allocation determining unit 116 determines that the allocation can not be allowed (N in S16), the impossible display generating unit 138 generates data for displaying that the allocation specified by the user is not allowed (S20), and the user is allowed to specify an examination room and a time frame anew (S14).

On the other hand, if the allocation determining unit 116 determines that the allocation of the specified examination room and the specified examination time to the examination specified by the user is allowed (Y in S16), the allocation unit 112 allocates the specified examination room and the specified examination time to the examination specified by the user, and stores the allocation information in the examination information storage 104 (S18). The unallocated display generating unit 132 and the schedule display generating unit 134 generates data for displaying an examination schedule screen image by reflecting examination information updated by the allocation, accordingly (S22).

In this fashion, the schedule presentation device according to the exemplary embodiment displays on a screen an examination schedule, which determines a time to perform an examination and an examination room to be used for the examination, in a manner where the examination schedule can be grasped intuitively. This allows a user (e.g., a person in charge of managing examinations, or the like) to perform a task of managing an examination schedule with an easy operation. Further, this enables effective scheduling management, can reduce wasted available time slots and wasted available examination rooms, and can utilize resources (e.g., examination rooms, examination equipment, medical staffs, or the like) effectively.

The examination information storage 104 in the medical service support system 10 stores an image captured by an imaging device (e.g., an endoscopic imaging device) and information regarding an examination and/or a treatment at the time of the examination and/or treatment.

When receiving an image transmitted from an imaging device, sometimes a notification of the termination of examination/treatment is received from the imaging device via the communication unit 102 before all of the images captured by the imaging device are sent. This occurs because image transmission process and a termination message are electronically notified separately and thus a termination notification is sometimes processed earlier than the transmission process of a captured image. In this case, an image transmitted after the reception of the termination notification may not be received, and target images may not be complete.

The schedule presentation device 100 comprises a termination requirement storage and a termination determining unit. The termination requirement storage stores termination requirements for determining whether or not it is proper to complete a process in accordance with a termination notification with respect to a captured image transmitted on a regular basis from the imaging apparatus and with respect to the termination notification that is transmitted instantly after an action of a user. The termination determining unit performs a termination process only in case that this termination notification satisfies the termination requirement.

Order information can be transmitted between the imaging apparatus and the schedule presentation device 100. Based on order information received from the schedule presentation device 100, the imaging apparatus starts a medical practice indicated in the order information (e.g., an endoscopic examination) and transmits a captured image to the schedule presentation device 100.

The imaging apparatus transmits captured images to the schedule presentation device 100 at predetermined time intervals (timer process). The schedule presentation device 100 stores a received captured image in the examination information storage 104. If a user instructs to terminate the medical practice, the imaging apparatus transmits a termination notification instantly to the schedule presentation device 100, and executes a termination process of the imaging apparatus even before the transmission of all of the captured images are completed.

When the schedule presentation device 100 receives a termination notification from the imaging apparatus, the termination process determining unit extracts termination requirements stored in the termination requirement storage, and performs a termination determining process. More specifically, the termination process determining unit compares the total number of images captured by the imaging apparatus that is notified along with the termination notification, and the number of captured images that have already been received by the schedule presentation device 100 (received number), and determines whether or not the total number and the received number agree with each other. If the termination determining unit determines to “agree,” the termination process of image capturing is performed. Simultaneously with the termination process, or after the termination process, the termination determining unit gives permission to start a process to be performed by a user subsequently (e.g., making a report).

When determining whether or not to agree by the termination determining unit, the determination may be made by comparing a list of images captured by the imaging apparatus with received images stored in the examination information storage 104 in the schedule presentation device 100, and by checking whether or not an image is identical to that in the list, one by one.

If the termination determining unit determines to “disagree,” whether or not the received number is more than or equal to the total number is determined. If the received number is less than the total number, the termination determining unit instructs the imaging apparatus to retransmit information on the number of captured images. Based on the retransmitted number of images, whether or not the received number is more than or equal to the total number is determined. In case that the received number is determined to be more than the retransmitted number of images, images that have not been transmitted from the imaging apparatus to the schedule presentation device 100 are determined to be deleted, and the termination process of image capturing is performed. In case that the received number is determined to be less than the retransmitted number of images, even based on the retransmitted information, inquiries are repeatedly sent to the imaging apparatus for a predetermined number. In case that the requirements are not satisfied as the result of the repetition, a message indicating that an un-received image exists is notified.

When the termination determining unit instructs to the imaging apparatus to retransmit, processes are executed in accordance with requirements with respect to “when the power of the imaging apparatus is turned on next time,” “when an image is transmitted from the imaging apparatus after the termination notification,” and “when another examination is terminated.”

In the manner described above, the next process (e.g., making a report) can be performed in a status where all the captured images are complete. Further, checking work in case disagreement occurs in the number of images can be alleviated.

Given above is an explanation based on the exemplary embodiment. The exemplary embodiments described above are intended to be illustrative only and various combinations of elements of the exemplary embodiments are also within the scope of the present invention. Various modifications could be developed based on the knowledge of those skilled in the art and such modifications are also within the scope of the present invention.

As described above, the present invention may be applicable to a system and a method for managing the schedule of medical facilities (e.g., an examination room or the like) with respect to a medical practice, such as an examination or the like.

What is claimed is:

1. A schedule presentation device that presents examination schedule information to a user, the examination schedule information including a time to perform an examination and an examination room to perform the examination, comprising:
an examination information processing unit operative to process examination information;
an examination information storage operative to store the examination information; and
a screen image generating unit operative to generate an examination schedule screen image configured as a 2-dimensional matrix where one axis indicates execution times of examinations and the other axis indicates examination rooms,
wherein the examination information processing unit comprises:
an allocated examination extraction unit operative to extract allocated examination information, which is information on examinations to which an execution time and an examination room are allocated, from the examination information stored in the examination information storage; and
an unallocated examination extraction unit operative to extract unallocated examination information, which is information on examinations to which an execution time or an examination room is not allocated, from the examination information stored in the examination information storage,
wherein, in the examination schedule screen image,
the axis of execution time indicates a time-undetermined-examination-displaying field for displaying examination information on an examination for which an examination time is not determined, along with a time of each examination of the examination information, and
the axis of examination room indicates an examination-room-undetermined-examination-displaying field for displaying examination information on an examination for which an examination room is not determined, along with an examination room of each examination of the examination information, and
wherein the screen image generating unit comprises:
a schedule display generating unit operative to generate data for displaying the allocated examination information extracted by the allocated examination extraction unit at a position specified by the axis of execution time and by the axis of examination room in a schedule display region for displaying the allocated examination information in the examination schedule screen image; and
an unallocated display generating unit operative to generate data for displaying the unallocated examination information, extracted by the unallocated examination extraction unit, in an unallocated examination display region including the time-undetermined-examination-displaying field and the examination-room-undetermined-examination-displaying field.

2. The schedule presentation device according to claim 1 further comprising:
an examination identification unit operative to identify one or more examinations based on a user input that specifies one or more examinations from examinations displayed in the unallocated examination display region or in the schedule display region; and
a schedule frame specifying unit operative to specify a time and an examination room based on a user input,
wherein the examination information processing unit further comprises an allocation unit that allocates the examination identified by the examination identification unit to the time and the examination room specified by the schedule frame specifying unit and stores information on the allocated time and the allocated examination room in the examination information storage,
wherein the unallocated display generating unit generates data for displaying the unallocated examination information where the examination to which the allocation unit has assigned the time and the examination room is excluded from examinations to be displayed in the unallocated examination display region, and
wherein the schedule display generating unit generates data for displaying the allocated examination information in the schedule display region while including the examination to which the allocation unit has assigned the time and the examination room in the allocated examination information.

3. The schedule presentation device according to claim 2,
wherein the examination information processing unit further comprises a potential frame extraction unit operative to extract potential allocation information indicating an examination room and a time that can be allocated to the examination identified by the examination identification unit, and
the screen image generating unit further comprises a potential frame emphasizing unit that generates data for displaying with an emphasis an allocatable examination room and an allocatable time on the basis of the potential allocation information extracted by the potential frame extraction unit.

4. The schedule presentation device according to claim 2 further comprising an allocation determining unit that determines whether or not the examination identified by the examination identification unit can be allocated to the time and the examination room specified by the schedule frame specifying unit,
wherein the screen image generating unit further comprises an impossible display generating unit that generates, if the allocation determining unit determines that the allocation is disallowed, data for displaying that the allocation is not allowed.

5. The schedule presentation device according to claim 2,
wherein the schedule display generating unit generates data for displaying one graphic symbol on a portion, to which one examination is allocated, of the schedule display region, and
wherein the examination identification unit identifies, based on a user input that specifies one graphic symbol of graphic symbols displayed in the schedule display region, an examination indicated by the one graphic symbol, and
the schedule presentation device further comprises a change specifying unit that specifies a change of a time allocated to the specified examination on the basis of a user input that instructs to deform the one graphic symbol,
wherein the examination information processing unit further comprises a time changing unit that changes the time allocated to the examination in the examination information on the basis of information specified by the change specifying unit, and stores the change in the examination information processing unit, and
wherein the schedule display generating unit generates data for displaying the allocated examination information based on the examination information updated by the time changing unit.

6. The schedule presentation device according to claim 1,
wherein the examination information processing unit further comprises:
a condition determining unit that determines whether or not a specification condition is satisfied with respect to each unallocated examination extracted by the unallocated examination extraction unit, the specification condition specifying an unallocated examination to which an examination room and a time should be allocated;
a potential frame extraction unit operative to extract potential allocation information that indicates an examination room and a time that can be allocated to an examination determined by the condition determining unit to satisfy the specification condition; and
an allocation unit that assigns an allocatable examination room and an allocatable time extracted by the potential frame extraction unit to the examination determined by the condition determining unit to satisfy the specification condition, and stores the allocation information in the examination information storage.

7. The schedule presentation device according to claim 1 wherein:
if the unallocated examination extraction unit extracts one or more examinations to which an examination room is not allocated, the unallocated display generating unit generates data for displaying the one or more examinations to which an examination room is not allocated in the unallocated examination display region;
if the unallocated examination extraction unit extracts one or more examinations to which a time is not allocated, the unallocated display generating unit generates data for displaying the one or more examinations to which a time is not allocated in the unallocated examination display region; and
if the unallocated examination extraction unit determines that neither an examination to which an examination room is not allocated nor an examination to which a time is not allocated is included in the examination information, the unallocated display generating unit determines not to display the unallocated examination display region.

8. The schedule presentation device according to claim 1,
wherein if the unallocated examination information extracted by the unallocated examination extraction unit does not include information on an examination to which an execution time is not assigned, the unallocated display generating unit determines not to display the time-undetermined-examination-displaying field, and
wherein the screen image generating unit generates the examination schedule screen image where the time-undetermined-examination-displaying field is not displayed.

9. The schedule presentation device according to claim 1,
wherein if the unallocated examination information extracted by the unallocated examination extraction unit does not include information on an examination to which an examination room is not assigned, the unallocated display generating unit determines not to display the examination-room-undetermined-examination-displaying field, and
wherein the screen image generating unit generates the examination schedule screen image where the examination-room-undetermined-examination-displaying field is not displayed.

10. The schedule presentation device according to claim 1 wherein if information on a plurality of unallocated examinations are extracted by the unallocated examination extraction unit, the unallocated display generating unit generates data for displaying information on a plurality of unallocated examinations in the unallocated examination display region in the examination schedule screen image, which is configured as a 2-dimensional matrix.
